(19) United States
(12) Patent Application Publication
(10) Pub. No.: US 2026/0003523 A1
(43) Pub. Date: Jan. 1, 2026

(54) COMPUTING DEVICE WITH A MEMORY OPTIMIZED FOR MATRIX CALCULATION

(71) Applicant: Commissariat à l'Energie Atomique et aux Energies Alternatives, PARIS (FR)

(72) Inventor: Eric GUTHMULLER, GRENOBLE (FR)

(21) Appl. No.: 19/244,672

(22) Filed: Jun. 20, 2025

(30) Foreign Application Priority Data
Jun. 28, 2024 (FR) 2407069

(51) Int. Cl. G06F 3/06

(52) U.S. Cl. CPC G06F 3/0626; G06F 3/0659; G06F 3/0673

(57) ABSTRACT

Computing device (100) comprising a main memory (104) configured to store a sparse matrix in a dense vector format (106, 108, 110) and to store a second vector (112) or a second matrix, a computing unit (102) configured to multiply the sparse matrix by the second vector or by the second matrix, and a streamer (114) comprising: an indexed loading block (116) comprising a secondary memory (118) and a FIFO memory (120) for requests to send values stored in the secondary memory to the computing unit; an indexed loading engine (122) configured to sequentially generate and store requests in the FIFO request memory according to an order in which the values are intended to be sent to the computing unit; the request storage order being calculated and stored in the form of firmware (124).

### FIELD

The present disclosure generally concerns the field of computing devices, or calculators, used in particular for the implementation of matrix calculations.

### BACKGROUND

Many high-performance computing (HPC) applications involve the implementation of matrix calculations, such as for example the solving of partial differential equation systems or of semantic graphs.

It is frequent for matrices involved in these calculations to correspond to hollow matrices, also known as sparse matrices, comprising a large number of null elements, or of zeros, with respect to the total number of elements. These calculations may in particular involve the execution of algorithms for the solving of linear problems formulated as equations of the type A·x=y (operation called “SpMV”), where A is a sparse matrix, x is a dense vector, and y is the result vector of this multiplication, or of the type A·X=Y, where X is a matrix, dense (operation called “SpMM”) or not (operation called “SpMSpM”), and Y is the result matrix of this multiplication. Now, it is relevant to optimize devices performing calculations with such matrices, in particular when very large sparse matrices comprising, for example, millions of zero elements, are concerned.

The algorithms used to solve equations involving sparse matrices are called linear solvers. There exist two main families of linear solvers: so-called “direct” solvers, which invert matrix A to perform the operation x=A⁻¹·y, and so-called “Krylov” solvers, based on an iterative algorithm that modifies vector x at each iteration until the solution is found.

Iterative solvers implement a plurality of matrix-vector multiplications at each iteration, with the same sparse matrix A used each time. For equations of the type A·x=y, only vector x changes at each iteration. Thus, it is relevant to optimize this operation, which accounts for the majority of the execution time of the operation.

There are different ways of performing a SpMV- or SpMM-type calculation. Thus, inner-product algorithms browse matrix A row by row, while outer-product algorithms browse it column by column. In an “inner-product” type algorithm, the reading of vector x or of matrix X takes place in a disordered fashion, which is dependent on the structure of matrix A. In an “outer-product” type algorithm, the accumulation performed in result vector y or result matrix Y is performed in a disordered manner.

There exist certain formats for storing sparse matrices, which avoid storing all the zeros in the matrix. These formats correspond for example to the CSR (Compressed Sparse Row) and CSC (Compressed Sparse Column) format. These formats enable to decrease the size of the memory required for their storage. On the other hand, they require browsing tables, which contain indices, that is, the row and column coordinates of non-zero elements as well as their values. The CSR representation consists in representing the matrix in the form of three dense vectors. The first vector stores the location of the beginnings of the matrix rows in the other two vectors. The second vector contains, for each row successively, the indices of the columns containing non-zero elements of the matrix. Finally, the third vector contains the non-zero elements themselves in the same order as the column indices. By going through these three vectors, it is easier to implement an “inner-product” algorithm, albeit at the cost of double indirection on the elements of vector x.

For so-called non-trivial matrices (that is, comprising more than one non-zero element per row), data are reused upon reading of vector x in the case of an “inner-product” algorithm, or upon accumulation of vector y in the case of an “outer-product” algorithm. However, the ability of the hardware to exploit this temporal reuse of the data will depend on the time period between two readings of the same element of vector x, or between two accumulations of vector y, in relation to the amount of data that the hardware can locally store.

In the case of an “inner-product” algorithm, accesses to vector x through a first-level cache of a processor are rather inefficient, as they make little use of the spatial locality inherent to cache structures, and the first access to a data item cannot be easily predicted, causing latency spikes decreasing the general performance of the computing device. The highest-performance general-purpose processors have implemented highly sophisticated, but complex, prediction solutions however having an unpredictable performance.

There exist sparse matrix-vector/dense matrix multiplication accelerators. Some of these accelerators use conventional caches, or cache memories, in their operation. Others use a circuit for loading memory accesses (known as a “streamer”) to supply them to the processor in the order of calculations to optimize multiplications. However, the hardware cost of these solutions is very high.

### SUMMARY

There exists a need to provide a computing device optimized for matrix computing involving a sparse matrix, in particular optimizing memory management with a lower hardware cost than prior art solutions.

An embodiment overcomes all or part of the disadvantages of existing solutions and provides a computing device comprising at least one main memory configured to store at least one sparse matrix in a dense vector format and to store at least one second vector or one second matrix, a computing unit configured to multiply the sparse matrix by the second vector or by the second matrix, and a streamer comprising:
an indexed loading block comprising a secondary memory configured to temporarily store values of the second vector or of the second matrix, and a FIFO request memory configured to store requests to send values stored in the secondary memory to the computing unit, each of the requests comprising at least one field of location within the secondary memory of the value intended to be sent to the computing unit upon execution of said request;
an indexed loading engine configured to generate and sequentially store requests in the FIFO request memory according to an order in which the values are intended to be sent to the computing unit, and to control, upon generation of each of the requests and in the absence in the secondary memory of the value intended to be sent to the computing unit upon execution of said request, the sending of said value from the main memory to the secondary memory;
and in which the request storage order is calculated and stored in the main memory in the form of firmware comprising a data vector specifying at least, for each of the values intended to be stored in the secondary memory, a portion of the field of location of said value within the secondary memory.

According to a specific embodiment, the firmware comprises a data vector specifying at least, for each of the values intended to be stored in the secondary memory, the field of location of said value within the secondary memory and a field of presence or not of said value in the secondary memory.

According to a specific embodiment, the streamer further comprises a linear loading block comprising a plurality of FIFO vector memories configured to store values of the dense vectors and of the data vector of the firmware, and to send a first part of these values to the computing unit and a second part of these values to the indexed loading engine.

According to a specific embodiment, the main memory is configured to store the sparse matrix in a CSR format, and:
a first one of the FIFO vector memories is configured to store values of a first one of the dense vectors corresponding to row indices of non-zero elements of the sparse matrix, and to send these values to the computing unit;
a second one of the FIFO vector memories is configured to store values of a second one of the dense vectors corresponding to the non-zero elements of the sparse matrix, and to send these values to the computing unit;
a third one of the FIFO vector memories is configured to store values of a third one of the dense vectors corresponding to column indices of the non-zero elements of the sparse matrix, and to send these values to the indexed loading engine;
a fourth one of the FIFO vector memories is configured to store values of the data vector of the firmware and to send these values to the indexed loading engine.

According to a specific embodiment, the linear loading block further comprises linear loading engines configured to send, to the main memory, requests to send the values of the dense vectors and of the data vector of the firmware to the FIFO vector memories.

According to a specific embodiment, the data vector of the firmware further specifies, for each of the values intended to be stored in the secondary memory, a distance field representative of the number of requests to be executed between the request to send said value and a previous request to send said value.

According to a specific embodiment, the indexed loading block is configured to determine a number of requests stored in the FIFO request memory, and to store in the FIFO request memory a request sent by the indexed loading engine when the value of the distance field of the received request is greater than the number of requests stored in the FIFO request memory.

According to a specific embodiment, the FIFO request memory is configured to store each of the requests with a field of confirmation of the execution of the request such that:
a request generated for a value present in the secondary memory is stored in the FIFO request memory with a first value of the field of confirmation of the execution of the request indicating that the request can be executed;
a request generated for a value absent from the secondary memory is stored in the FIFO request memory with a second value of the field of execution of the request indicating that the request cannot be executed yet, this second value being replaced by the first value when the value is subsequently received and stored in the secondary memory.

According to a specific embodiment, the firmware is calculated in such a way that the values of the location field in the data vector are determined by applying a replacement policy depending on the use of the data.

According to a specific embodiment, the replacement policy implements an LRU- and/or Belady-type algorithm.

According to a specific embodiment, the firmware is calculated in such a way that, for each of the values of the second vector or of the second matrix intended to be sent to the computing unit and already present in the secondary memory, the replacement policy is updated by considering the locations of said values in the secondary memory.

According to a specific embodiment, the firmware is calculated in such a way that, for each of the values of the second vector or of the second matrix intended to be sent to the computing unit and absent from the secondary memory and when the secondary memory is not full, said value is stored in a free location of the secondary memory.

According to a specific embodiment, the firmware is calculated in such a way that, for each of the values of the second vector or of the second matrix intended to be sent to the computing unit and absent from the secondary memory and when the secondary memory is full, a location in the secondary memory occupied by a value is selected in accordance with the applied replacement policy and said value is stored in the selected location of the secondary memory.

According to a specific embodiment, the indexed loading block comprises at least one directory configured to store, for each value intended to be stored in the secondary memory, the address of said value in the main memory, and the data vector of the firmware specifies, for each of the values intended to be stored in the secondary memory, an indication of the location of said value within the secondary memory.

According to a specific embodiment, the indexed loading block further comprises at least one counter configured to count the data exchanged by the indexed loading block.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows an example of a computing device according to a specific embodiment;

FIG. 2 shows an example of a flowchart of operation of a computing device according to a specific embodiment;

FIG. 3 shows an example of a flowchart implemented for a calculation of firmware used in a computing device according to a specific embodiment;

FIG. 4 schematically shows an example of a computing device according to a variant of the specific embodiment.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, various elements (computing unit, main memory, secondary memory, loading blocks, streamers, etc.) of the computing device are not detailed. Those skilled in the art will be capable of designing these elements in detail based on the functional description given herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings in a normal position of use.

Unless specified otherwise, the expressions “about”, “approximately”, “substantially”, and “in the order of” signify plus or minus 10%, preferably of plus or minus 5%.

Throughout the document, the term “vector” is used to designate a row matrix or a column matrix.

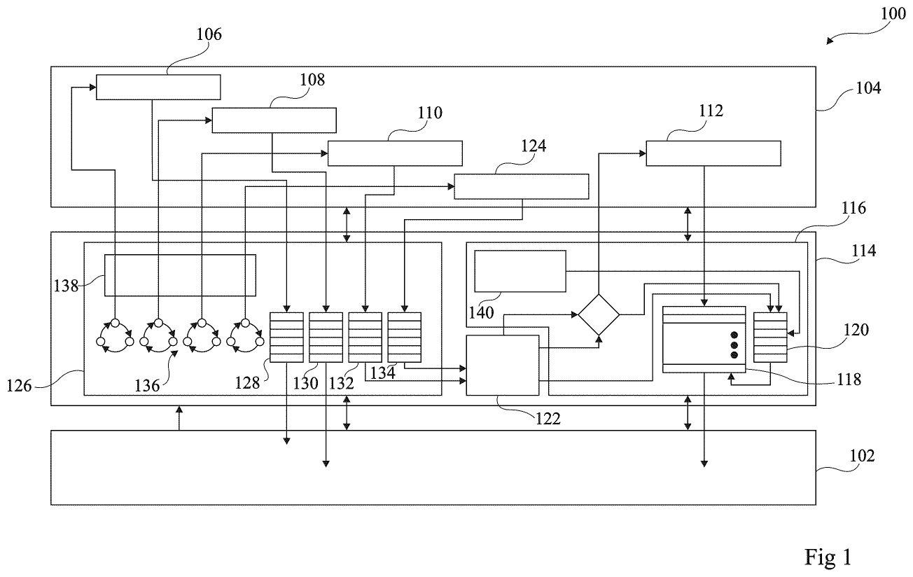

An example of a computing device 100 according to a specific embodiment is described hereafter in relation with FIG. 1. In the described example, device 100 is configured to implement algorithms for multiplying a sparse matrix A with a second vector b (operation SpMV) or a second matrix B (operation SpMM).

Device 100 comprises a computing unit 102, which for example corresponds to a processor such as a CPU (Central Processing Unit) or a GPU (Graphics Processing Unit) or any other electronic/computer circuit adapted to the implementation of the calculations performed by device 100.

Device 100 also comprises a main memory, or external memory, 104, for example of RAM (Random Access Memory) type, typically a DRAM (Dynamic Random Access Memory). Main memory 104 is configured to store in particular at least one sparse matrix in a dense vector format.

In the example of FIG. 1, main memory 104 stores a sparse matrix in a CSR format, that is, in the form of data stored in a first dense vector 106 comprising the row indices of the non-zero elements of the sparse matrix, in a second dense vector 108 comprising the non-zero elements of the sparse matrix, and in a third dense vector 110 comprising the column indices of the non-zero elements of the sparse matrix. In the CSR format, the row indices point, for each row of the matrix, to the index of the beginning of this row in the column index and non-zero element vectors.

As a variant, it is possible for main memory 104 to store the sparse matrix in a dense vector format other than the CSR format. The encoding format of the sparse matrix being calculated by device 100 may, for example, be selected according to the internal structure of the matrix and/or to the characteristics of computing unit 102.

For example, it is possible for main memory 104 to store the sparse matrix in a COO (COOrdinate list) format in which each non-zero element of the sparse matrix, stored in a dense vector, is associated with its row/column coordinates in the matrix, these coordinates being stored in two other dense vectors. These coordinates may be sorted to enable a more efficient implementation of a multiplication of the sparse matrix with a vector or another matrix.

According to another example, it is possible for main memory 104 to store the sparse matrix in a BCSR (Block Compressed Sparse Row) or BSR (Block Sparse Row) format, in which dense blocks of fixed size (2 rows×2 columns, for example) are stored per index. This format takes advantage of the fact that matrices are often locally dense and generally sparse. It thus decreases the number of indices stored in memory, at the cost of the insertion of zeros in the dense blocks. Heuristics for example enable to select the ideal size for these dense blocks.

According to another example, the sparse matrix may be stored in CSC format to perform, for example, a multiplication of the type A^{T}·x=y where A^{T} is the transpose matrix of A.

As a variant, other formats of sparse matrix storage in the form of dense vectors are possible. For example, any form of deterministic indirection pointing to elements or dense sub-blocks of a sparse matrix may be used. The format of storage of the sparse matrix in main memory 104 may in particular be selected so that it is adapted to the way in which the multiplication algorithm implemented in computing unit 102 browses the sparse matrix. For example, a storage of the sparse matrix in CSR format may be advantageous in the case of matrix multiplication involving an algorithm of “inner-product” type, while a storage of the sparse matrix in CSC format may be advantageous in the case of a matrix multiplication involving an algorithm of “outer-product” type.

Main memory 104 is also configured to store at least one second vector or one second matrix intended to be multiplied with the sparse matrix. In the example of FIG. 1, a second vector 112 is stored in main memory 104.

Device 100 also comprises a loading circuit 114, or streamer, optimized for the memory loading of data for the implementation of a multiplication of the sparse matrix by the second vector 112 or by the second matrix. Streamer 114 comprises at least:
an indexed loading block 116 comprising a secondary memory 118 configured to temporarily store values of the second vector 112 or of the second matrix, and a request FIFO (First In First Out) memory 120 configured to store requests to send values stored in secondary memory 118 to computing unit 102;
an indexed loading engine 122 configured to generate and sequentially store the requests in FIFO request memory 120 according to an order in which the values are intended to be sent to computing unit 102, and to control, upon generation of each of the requests and in the absence in secondary memory 118 of the value intended to be sent to computing unit 102 during the execution of the request, the sending of said value from main memory 104 to secondary memory 118.

Each of the requests intended to be stored in FIFO request memory 120 comprises at least one location field, representative of the location within secondary memory 118, of the value intended to be sent to computing unit 102 during an execution of the request. Further, in the described example, FIFO request memory 120 is configured to store each of the requests with a field of confirmation of the execution of the request such that:
a request generated for a value present in secondary memory 118 is stored in FIFO request memory 120 with a first value of the field of confirmation of the execution of the request indicating that the request can be executed;
a request generated for a value absent from secondary memory 118 is stored in FIFO request memory 120 with a second value of the field of execution of the request indicating that the request cannot be executed yet, this second value being replaced with the first value when the value is subsequently received and stored in secondary memory 118.

In the example of FIG. 1, main memory 104 is also configured to store firmware 124 comprising a data vector specifying at least, for each of the values intended to be stored in secondary memory 118, the field of location of the value within secondary memory 118 and a field of presence or not of the value in secondary memory 118. Firmware 124 comprises memory control data, the function of which is detailed below, and which are decoded by indexed loading engine 122.

As a variant, firmware 124 may be stored within one of the dense vectors of the sparse matrix, for example the third vector 110 comprising the column indices, by reserving certain bits of this vector for the storage of this firmware 124 (for example by using the most significant bits of the column indices of the CSR format).

In the example of FIG. 1, streamer 114 further comprises a linear loading block 126 comprising a plurality of FIFO vector memories configured to store the values of dense vectors 106, 108, 110 and of data vector of firmware 124 stored in main memory 104. In the example of FIG. 1, a first FIFO vector memory 128 is configured to receive the values of the row indices stored in first dense vector 106, a second FIFO vector memory 130 is configured to receive the values of the non-zero elements of the sparse matrix stored in the second dense vector 108, a third FIFO vector memory 132 is configured to receive the values of the column indices stored in the third dense vector 110, and a fourth FIFO vector memory 134 is configured to receive the values of the data vector of firmware 124.

In the example of FIG. 1, linear loading block 126 further comprises linear loading engines 136 configured to send requests to the main memory 104 to send the values of dense vectors 106, 108, 110 and of the data vector of firmware 124 to FIFO vector memories 128, 130, 132, and 134. In the configuration shown in FIG. 1, these requests are sent to a first MSHR 138 (“Miss Status Handling Register”), or register or tracker, configured to retransmit these requests to main memory 104. These linear loading engines 136 correspond, for example, to finite state machines (FSM) programmed in software manner in linear loading block 126.

Thus, linear sequencing block 126 is configured to read from and load into memory the values of the dense vectors 106, 108, 110 representing the sparse matrix, as well as the firmware 124 stored in main memory 104. Part of the information stored in FIFO memories 128, 130, 132, and 134 is sent to computing unit 102 to execute the external and internal loops of the multiplication of the sparse matrix by the second vector 112. In the described example, this information corresponds to the values of the row indices and of the non-zero elements stored in the first and second FIFO vector memories 128, 130. Another part of this information is sent to indexed loading engine 122, that is, the values of the column indices and of the data vector of firmware 124 stored in the third and fourth FIFO memories 132, 134.

Indexed loading engine 122 is configured to control, upon generation of each of the requests and in the absence in secondary memory 118 of the value intended to be sent to computing unit 102 upon execution of said request, the sending of this value from main memory 104 (stored in the second vector 112) to secondary memory 118. In the example of FIG. 1, this control is performed via a second MSHR 140. The second MSHR 140 may enable to keep track of missing elements in secondary memory 118, and thus of the accesses to main memory 104 performed to obtain values from the second vector 112. This second MSHR 140 may also enable to group the requests sent to main memory 104 and thus more efficiently use the memory bus between main memory 104 and streamer 114. Indexed loading engine 122 may in particular be configured to calculate the addresses, within the second vector 112, at which are stored the values to be sent to secondary memory 118.

Thus, secondary memory 118 forms a memory in which the values of the second vector 112 or of the second matrix are stored. Accesses to main memory 104 are generated by indexed loading engine 122 in case of an absence of the desired value in secondary memory 118, that is, according to the indicator of the presence or not of said value in secondary memory 118 provided by firmware 124.

Once the elements of the second vector 112 or of the second matrix are present in secondary memory 118, the sequential execution of the requests stored in FIFO request memory 120 sends, in the same order as that of the execution of these requests, the data to computing unit 102 so that the latter can execute the matrix multiplication algorithm between the sparse matrix and the second vector 112 or the second matrix. The sending requests are thus sequentially stored in FIFO request memory 120 according to an order in which the values of the second vector 112 or of the second matrix are intended to be sent to computing unit 102. This order of execution of the requests enables streamer 114 to remain synchronized with computing unit 102 upon execution of the matrix calculation.

The data originating from the second vector 112 or from the second matrix may be of variable precision. Thus, the number of entries in secondary memory 118, that is, the number of data of the second vector 112 or of the second matrix that can be stored in secondary memory 118, may depend on the selected accuracy, specified by the selection of the configuration of streamer 114.

In the described example of embodiment, the data vector of firmware 124 further comprises, for each of the values to be stored in secondary memory 118, a distance field having a value representative of the number of requests to be executed between the request to send this value and a previous request to send said value. Further, in the described example of embodiment, indexed loading block 116 may be configured to determine a remaining number of requests stored in FIFO request memory 120, and to store in FIFO request memory 120 a request sent by indexed loading engine 122 when the received value of the distance field is smaller than the remaining number of requests stored in FIFO request memory 120. For example, at the input of indexed loading block 116, request and response counters, for example integrated in the second MSHR 140, may enable to block or to let through a request sent to main memory 104 according to the value of the distance field associated with the request. Such a blocking may be used to avoid premature replacement of a data item stored in secondary memory 118, and ultimately avoid the sending back of an erroneous data item to computing unit 102.

In the described example of embodiment, firmware 124 may be calculated in such a way that the values of the location field in the data vector of firmware 124 are determined by applying a replacement policy in secondary memory 118 which is a function of the use of the data. Firmware 124 can thus be used to manage the occurrence of a conflict at the time of a replacement of a data item in secondary memory 118 by another data item originating from the second vector 112 or from the second matrix and sent to secondary memory 118. Such a conflict may occur when the location in secondary memory 118 at which a data item is to be stored contains a data item not yet read by computing unit 102. Although the applied replacement policy can minimize the occurrence of such a conflict, the latter may occur, for example, when a large number of data items are intended to be stored in secondary memory 118 and there are few locations therein (for example in the case of the storage of large data blocks and/or in the case of a very high precision of the stored data).

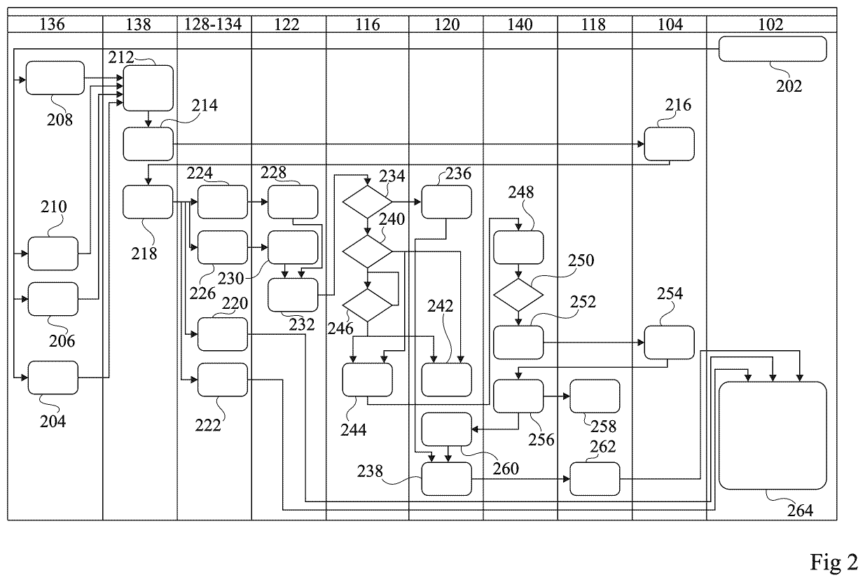

An example of operation of device 100 is described hereafter in relation with FIG. 2, which schematically shows a flowchart of the operation of device 100. In this flowchart, the implemented steps are grouped in columns, each corresponding to one of the elements of device 100 (the reference numeral of each of these elements is indicated in the column corresponding to this element).

In a step 202, computing unit 102 configures streamer 114 and starts linear loading engines 136. This configuration step may consist in loading into streamer 114 elements such as the base addresses of the vectors and matrices, the size of the elements of each vector and matrix, and the fixed pitch (“stride”) separating them, the number of elements of each vector and matrix, the number of elements of the dense matrix to be loaded at each request in the case of a SpMM-type operation, the operating mode of indexed loading block 116 (similar to that of a cache memory or of a FIFO memory), signals for controlling the starting and the stopping of the loading of data, etc. Linear loading engines 136 receive the received configuration from computing unit 102 and start upon reception of the start control signal. Linear loading engines 136 thus start the reading of the various dense vectors 106, 108, and 110 describing the sparse matrix as well as firmware 124 (steps 204, 206, 208, and 210 respectively corresponding to the loading of vectors 106, 108, 110, and 124). For example, for the loading of each of these vectors, linear loading engines 126 group requests to send the data of these vectors, for example intended for a same cache line (typically 512 bits) or of the width of the memory bus coupling linear loading block 126 to main memory 104, before sending an aggregated request to the first MSHR 138. For example, in a step 212, the first MSHR 138 may perform an arbitration between requests received from linear loading engines 136. The first MSHR 138 can then send these requests to main memory 104 (step 214).

Main memory 104 can then send the requested values to the first MSHR 138 (step 216). When the data requested in the requests are sent by main memory 104, they are received by the first MSHR (step 218) and then sent to the various FIFO vector memories of linear loading block 126 (steps 220, 222, 224, and 226 respectively corresponding to the storage in FIFO vector memories 128, 130, 132, and 134).

In the described example, the values of the column indices and of the data vector of firmware 124 are sent to indexed loading engine 122, which calculates the addresses of the values in the second vector 112 or the second matrix (step 228) and decodes firmware 124 (step 230). The indexed loading engine can then generate the requests to be sent to indexed loading block 116 (step 232).

For each received request, indexed loading block 116 may verify that there is at least one available space in FIFO request memory 120 and blocks the processing of the request if FIFO request memory 120 is full.

For each received request, indexed loading block 116 may then test the value of the field of presence or not of said value in secondary memory 118 (step 234).

If the value is already present in secondary memory 118 (occurrence of a “hit”), indexed loading block 116 can send this request to FIFO request memory 120 with the field of confirmation of the execution of the request at a first value indicating that the request can be executed (step 236) and read the next request sent by the indexed loading engine (step 238).

If the value is absent from secondary memory 118 (occurrence of a “miss”), indexed loading block 116 tests whether the value of the distance field of this request is zero (step 240). If this value is zero, indexed loading block 116 sends this request to FIFO request memory 120 with the field of confirmation of the execution of the request at a second value indicating that the request cannot be executed yet (step 242) and sends to the second MSHR 140 a request to send a value from the second vector 112 or the second matrix (step 244). If the value of the distance field of this request is not zero, the value of this field is compared with the number of requests present in FIFO request memory 120 (step 246). If the value of this field is greater than the number of requests present in FIFO request memory 120, indexed loading block 116 sends this request to FIFO request memory 120 with the field of confirmation of the execution of the request at the second value (step 242) and sends to the second MSHR 140 a request to send a value from the second vector 112 or the second matrix (step 244). Otherwise, this test is repeated until the number of requests present in FIFO request memory 120 is smaller than the value of the distance field, thus blocking the request as long as FIFO request memory 120 contains more requests than the value of the distance field.

After the reception of a plurality of requests, the second MSHR 140 may attempt to group one or a plurality of current memory requests (steps 248, 250), and then transmit them to main memory 104 (step 252) if the grouping fails.

Upon reception of the request(s) sent by the second MSHR 140, main memory 104 can send the requested values to the second MSHR 140 (step 254). Upon reception of these values by the second MSHR (step 256), the received value(s) can be sent to secondary memory 118 for writing (step 258), and the field of confirmation of the execution of the request can be updated in FIFO request memory 120 by passing it to the first value (step 260). FIFO request memory 120 can then read the next request sent by the indexed loading engine (step 238).

In the presence of a request stored with the confirmation field at the first value indicating that the request can be executed, at the top of FIFO request memory 120, secondary memory 118 transmits the stored values to computing unit 102 (step 262), the latter implementing the multiplication calculation algorithm between the sparse matrix and the second vector 112 or the second matrix based on the data received from FIFO vector memories 128, 130, 132, and 134 and secondary memory 118 (step 264).

As previously indicated, firmware 124 specifies at least, for each of the values intended to be stored in secondary memory 118, a field of location of said value within secondary memory 118 and a field of presence or not said value in secondary memory 118. This firmware 124 is precalculated before implementing the steps previously described in relation with FIG. 2.

The fact for firmware 124 to be precalculated allows the implementation of a replacement policy for the data stored in secondary memory 118 (when a data item from the second vector 112 or the second matrix is to be written into secondary memory 118 but the latter is full) which would be very costly to implement in hardware fashion.

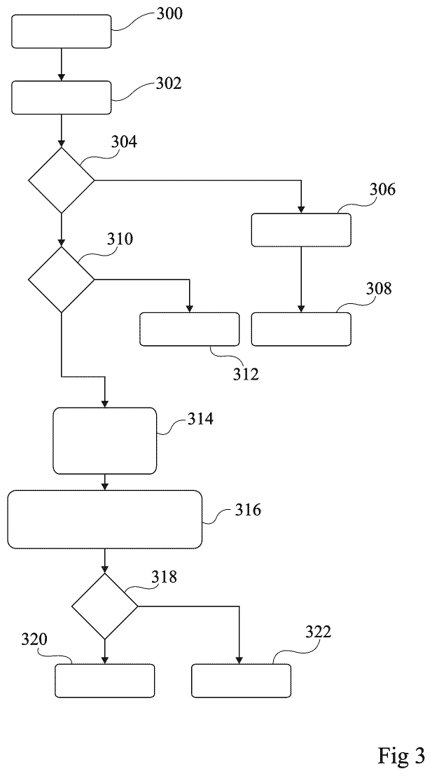

FIG. 3 shows an example of a flowchart implemented for the calculation of firmware 124. In the described example, firmware 124 comprises a sequence of triplets (location field, field of presence or not, distance field) each associated with one of the non-zero elements of the sparse matrix. The location field is used to locate the data item in secondary memory 118. The field indicates whether the data item is present in secondary memory 118, or whether it needs to be loaded into secondary memory 118 from main memory 104. Finally, the value of the distance field is representative of the number of requests to be executed between two consecutive requests to send the value associated with the request and stored in secondary memory 118, and is used to avoid replacing a data item stored in secondary memory 118 which has not been read by computing unit 102 yet.

This flowchart may be implemented by computing unit 102 or another processor (for example, a host processor) or a dedicated accelerator of device 100.

A column index of the sparse matrix is first considered (step 300). At step 302, an internal representation of secondary memory 118 contained in the program implementing this flowchart is inspected. It is then verified whether the value of the second vector 112 or of the second matrix associated with this column index is present in secondary memory 118 (step 304). If so, the replacement policy is updated (step 306), for example by placing this data item at the end of a list of the least used data in the case of a replacement policy of LRU type (“Least Recently Used”, in which the least recently used row is replaced first). The data of firmware 124 (a triplet in the described example) associated with this value are then defined in such a way that the location field points to the address in secondary memory 118 where the data item is located, the field of presence or not indicates the presence of the data item in secondary memory 118, and the distance field is set to 0 (step 308). In the case where the value is not present in secondary memory 118, it is verified whether secondary memory 118 is full (step 310). If this is not the case, the triplet associated with this value is defined in such a way that the location field indicates a free address in secondary memory 118, the presence or absence field indicates the absence of the data in secondary memory 118, and the distance field is set to 0 (step 312).

If secondary memory 118 is full, a value stored in secondary memory 118 is selected to be evicted (step 314). For example, in the case of the application of an LRU-type replacement policy, the value present at the top of the list of least used entries is selected as being that to be evicted. Once this entry has been selected, it is verified that the replaced value is not currently in use, in order to guarantee that computing unit 102 has read this value. For this purpose, a distance between the current request and that which has used this value for the last time is calculated (step 316), after which this distance is compared with the size of FIFO request memory 120 (step 318). If this distance is greater than the size of FIFO request memory 120, it is possible to consider that the considered value has already been read by computing unit 102 when the selected value is replaced. In this case, the triplet associated with this value is defined in such a way that the location field indicates the address of the value to be evicted, the field of presence or not of the value indicates the absence of the value in secondary memory 118, and the distance field is set to 0 (step 320). Otherwise, the triplet associated with this data item is defined in such a way that the location field indicates the address of the value to be evicted, the field of presence or not indicates the absence of the value in secondary memory 118, and the distance field is set to the value of the calculated distance (step 322).

In the above example, the replacement policy applied to define the vector data of firmware 124 is of LRU type. As a variant, it is possible for this replacement policy to correspond to an optimal algorithm, or Belady algorithm, in which the replaced value is that which will not be used for the longest period of time to come. The use of such a replacement policy enables to produce a better hit rate, that is, a higher frequency of cases where the values being requested are already present in secondary memory 118. However, the application of this replacement policy creates the risk of replacing a value which has not been read by computing unit 102 yet, which may cause a conflict and a blocking decreasing the performance of device 100.

According to another variant, it is possible to apply a replacement policy for values stored in secondary memory 118 combining LRU-and Belady-type replacement policies. To achieve this, it is possible to only apply the Belady replacement policy to a limited number N of values stored in secondary memory 118, corresponding to those least recently used. Such a variant limits the above-discussed risks of conflict. The value of N may be modulated according to the storage capacity of secondary memory 118, which also depends on the size of the data to be stored.

As a variant, other types of replacement policies may be implemented, for example of pseudo-LRU type.

As a variant of the previously-described examples, indexed loading block 116 may comprise a directory 142 comprising, for example, for each entry in secondary memory 118, the address of this data item in main memory 104. This directory 142 enables to envisage uses of device 100 where only part of the replacement policy is precalculated, or even to temporarily implement the matrix calculation without using firmware 124, for example during the calculation of this firmware 124. Further, when indexed loading block 116 comprises such a directory 142, the data in firmware 124 may not comprise the field of presence or not of the considered request value. Further, in such a variant, firmware 124 may at least partially provide the number of the concerned way of secondary memory 118 so as to consult a smaller number of entries to determine the presence or the absence of the relevant data item.

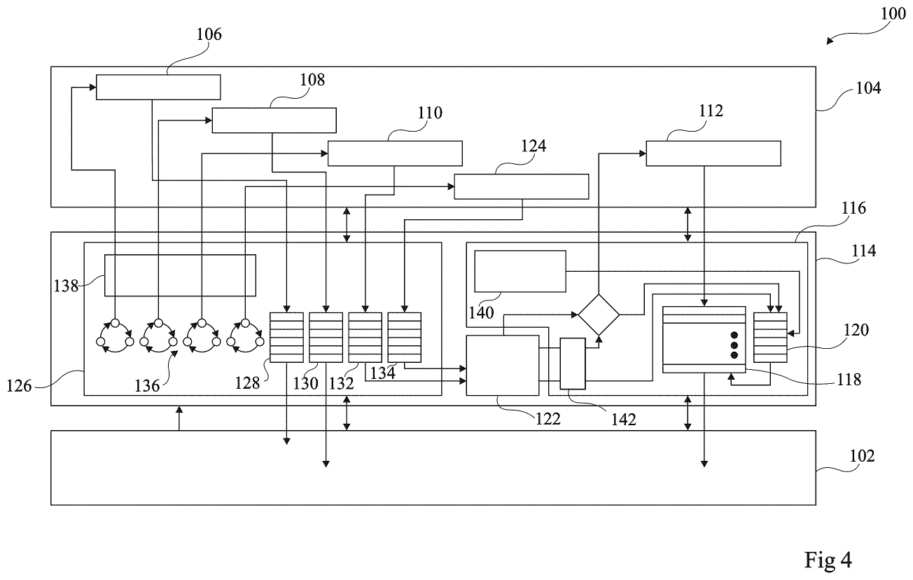

FIG. 4 schematically shows an example of embodiment of a device 100 comprising such a directory 142. In this variant, device 100 comprises all the elements previously described in relation with FIG. 1, as well as the directory 142 included in indexed loading block 116. This directory 142 includes, for each entry of secondary memory 118, its address in secondary memory 118.

In this variant, firmware 124 forms a data vector specifying, for each of the values intended to be stored in secondary memory 118, an indication of the location of said value within secondary memory 118, this location indication corresponding, for example, to part of the way number of the cache formed by directory 142 and secondary memory 118. This indication of the location of the data item is transmitted from indexed loading engine 122 to directory 142, which can then transmit to FIFO request memory 120 the complete address of the concerned data item.

In such a variant, the secondary memory 118 associated with directory 142 can be seen as operating as one associative cache per set. This variant enables to decrease the hardware and energy cost associated with the consulting of directory 142.

When firmware 124 only comprises, for each of the values intended to be stored in secondary memory 118, an indication of the location of said value within secondary memory 118, and firmware 124 comprises no field representative of the presence or not of the data item in secondary memory 118, this presence or not can be determined, for example, by partially consulting directory 142. Multiplexers may receive at their input the responses from the various parts of directory 142, as well as the portion of the location stored in firmware 124, to select the concerned response. The presence or not of the data item in secondary memory 118 can then be determined from the responses obtained at the output of the multiplexers.

As a variant of the above-described example, it is possible for firmware 124 to comprise the field of presence or not of the value of the considered request, and possibly the distance field having a value representative of the number of requests to be executed between the request to send this value and a previous request to send said value.

According to a variant, indexed loading block 116 may also have a so-called “FIFO” operating mode, in which secondary memory 118 operates as a FIFO memory. In this case, the values of the second vector 112 or of the second matrix sent from main memory 104 to secondary memory 118 may be stored one after the other in secondary memory 118, regardless of their address in secondary memory 118. This mode may also be used while waiting for firmware 124 to be calculated, or when the sparse matrix has an extremely low number of non-zero values per row of the matrix.

In the previously-described examples of embodiment, it is considered that computing unit 102 performs a matrix calculation by implementing an “inner-product” type algorithm. As a variant, computing unit 102 may implement other types of algorithm (of “outer-product”, Gustavson type, etc.) to perform these matrix calculations.

As a variant of the previously-described examples of embodiment, device 100 may carry out the steps previously described in relation with FIG. 2 on part only of the data of the sparse matrix, that is, on a sub-matrix of the sparse matrix.

Device 100 may advantageously be used to perform a multiplication of a sparse matrix with a dense vector or a dense matrix. As a variant, device 100 may be used to perform a multiplication of a sparse matrix with a vector or a matrix having elements which are not dense but separated by a fixed distance in memory. Such a variant may be used, for example, to work on a field of a structure (a vector of complex numbers or a vector of three-dimensional vectors, for example). According to another variant, device 100 may be used to perform a multiplication of a sparse matrix with dense blocks of a dense matrix, where the elements of the dense blocks may or may not be spaced apart from one another with a fixed spacing.

As a variant, indexed loading block 116 may comprise at least one usage counter configured to count the data exchanged by block 116. In this case, the data vector stored in firmware 124 may not comprise the distance field, given that such counters enable to detect usage conflicts in secondary memory 118 and to wait for the release of a value before performing the replacement within secondary memory 118.

According to another variant, it is possible for a specific value of the distance field in the data vector of firmware 124 to be used to indicate the presence or not of the data in secondary memory 118. This value may be replaced on the fly in indexed loading engine 122 by this value incremented by one unit.

According to an alternative embodiment, device 100 may further comprise an accelerator configured to work upstream or in parallel with streamer 114 and execute the flowchart previously described in relation with FIG. 3.

The different previously-described variants may be combined with one another.

Device 100 enables an optimized management of a cache for the implementation of a multiplication of a sparse matrix by a dense vector or a dense matrix, with a configurable precision.

Device 100 may enable to precalculate the replacement policy in secondary memory 118 in the case of the multiplication of the sparse matrix by a dense vector or a dense matrix. This precalculation may be partial: on part of the matrix only (a sub-matrix) and/or on part of secondary memory 118 only (for example to select a subset of ways in secondary memory 118).

Device 100 may be applied to form a fully associative cache, with no hardware dedicated to the detection of conflicts on a same data item sent to the input of the cache. In this case, everything is precalculated and stored in a microcode formed by firmware 124. An ideal replacement policy can then be used, with a far higher performance than what can be done in real time in hardware fashion.

Device 100 enables to improve the performance of a multiplication of a sparse matrix by a dense vector or a dense matrix due to the decrease in the number of accesses to the main memory by the computing unit, due to the use of the temporal locality of the data used, which depends on the structure of the sparse matrix. This temporal locality is due to the fact that the numerous SpMV or SpMM multiplications implemented use the same data of the sparse matrix, and thus the same memory access sequencing at each multiplication.

Device 100 enables to precalculate the management of secondary memory 118 to decrease its hardware cost and improve performance. Device 100 enables to precalculate the behavior of secondary memory 118, that is, the calculation of the hit and the selection of a location for the replacement of an entry of secondary memory 118, in the form of firmware 124.

Device 100 enables to find a compromise between the hit rate and the occurrence of conflicts during data replacements in secondary memory 118 (that is, the selection of a cache line still in use).

Device 100 forms an accelerator, or a streamer, with an extended and variable precision, in which the most critical software routines are optimized. This accelerator enables to limit as much as possible memory accesses, which are costly in terms of performance and energy, by integrating a cache. This accelerator is coupled to the computing core via existing data paths, and thus make it compatible with multiple cores. Further, this accelerator is compatible with the needs for data reading with an extended precision, and can be configured down to the bit.

Device 100 may be used to form a fully associative cache at a lower cost than if such a cache was implemented purely in hardware fashion.

The precalculation of the indexing vector enables to use replacement policies that would be impossible to implement in hardware fashion in real time.

Device 100 may for example be used in the field of scientific computing or that of artificial intelligence, for example in algebraic solvers, eigenvalue solvers, in artificial intelligence inference and training.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. Computing device comprising at least one main memory configured to store at least one sparse matrix in a dense vector format and to store at least one second vector or one second matrix, a computing unit configured to multiply the sparse matrix by the second vector or by the second matrix, and a streamer comprising:
an indexed loading block comprising a secondary memory configured to temporarily store values of the second vector or of the second matrix, and a FIFO request memory configured to store requests to send values stored in the secondary memory to the computing unit, each of the requests comprising at least one field of location within the secondary memory of the value intended to be sent to the computing unit upon execution of said request;
an indexed loading engine configured to generate and sequentially store requests in the FIFO request memory according to an order in which the values are intended to be sent to the computing unit, and to control, on generation of each of the requests and in the absence in the secondary memory of the value intended to be sent to the computing unit upon execution of said request, the sending of said value from the main memory to the secondary memory;
and wherein the request storage order is calculated and stored in the main memory in the form of firmware comprising a data vector specifying at least, for each of the values intended to be stored in the secondary memory, a portion of the field of location of said value within the secondary memory.

2. Computing device according to claim 1, wherein the firmware comprises a data vector specifying at least, for each of the values intended to be stored in the secondary memory, the field of location of said value within the secondary memory and a field of presence or not of said value in the secondary memory.

3. Computing device according to claim 1, wherein the streamer further comprises a linear loading block comprising a plurality of FIFO vector memories configured to store values of the dense vectors and of the data vector of the firmware, and to send a first part of these values to the computing unit and a second part of these values to the indexed loading engine.

4. Computing device according to claim 3, wherein the main memory is configured to store the sparse matrix in a CSR format and wherein:
a first one of the FIFO vector memories is configured to store values of a first one of the dense vectors corresponding to row indices of non-zero elements of the sparse matrix, and to send these values to the computing unit;
a second one of the FIFO vector memories is configured to store values of a second one of the dense vectors corresponding to the non-zero elements of the sparse matrix, and to send these values to the computing unit;
a third one of the FIFO vector memories is configured to store values of a third one of the dense vectors corresponding to column indices of the non-zero elements of the sparse matrix, and to send these values to the indexed loading engine;
a fourth one of the FIFO vector memories is configured to store values of the data vector of the firmware and to send these values to the indexed loading engine.

5. Computing device according to claim 3, wherein the linear loading block further comprises linear loading engines configured to send to the main memory requests to send the values of the dense vectors and of the data vector of the firmware to the FIFO vector memories.

6. Computing device according to claim 1, wherein the data vector of the firmware further specifies, for each of the values intended to be stored in the secondary memory, a distance field representative of the number of requests to be executed between the request to send said value and a previous request to send said value.

7. Computing device according to claim 6, wherein the indexed loading block is configured to determine a number of requests stored in the FIFO request memory, and to store in the FIFO request memory a request sent by the indexed loading engine when the value of the distance field of the received request is greater than the number of requests stored in the FIFO request memory.

8. Computing device according to claim 1, wherein the FIFO request memory is configured to store each of the requests with a field of confirmation of the execution of the request such that:
a request generated for a value present in the secondary memory is stored in the FIFO request memory with a first value of the field of confirmation of the execution of the request indicating that the request can be executed;
a request generated for a value absent from the secondary memory is stored in the FIFO request memory with a second value of the field of execution of the request indicating that the request cannot be executed yet, this second value being replaced by the first value when the value is subsequently received and stored in the secondary memory.

9. Computing device according to claim 1, wherein the firmware is calculated in such a way that the values of the location field in the data vector are determined by applying a replacement policy dependent on the use of data.

10. Computing device according to claim 9, wherein the replacement policy implements an LRU- and/or Belady-type algorithm.

11. Computing device according to claim 9, wherein the firmware is calculated in such a way that, for each of the values of the second vector or of the second matrix intended to be sent to the computing unit and already present in the secondary memory, the replacement policy is updated by considering the locations of said values in the secondary memory.

12. Computing device according to claim 9, wherein the firmware is calculated in such a way that, for each of the values of the second vector or of the second matrix intended to be sent to the computing unit and absent from the secondary memory and when the secondary memory is not full, said value is stored in a free location of the secondary memory.

13. Computing device according to claim 9, wherein the firmware is calculated in such a way that, for each of the values of the second vector or of the second matrix intended to be sent to the computing unit and absent from the secondary memory and when the secondary memory is full, a location in the secondary memory occupied by a value is selected in accordance with the applied replacement policy and said value is stored at the selected location of the secondary memory.

14. Computing device according to claim 1, wherein the indexed loading block comprises at least one directory configured to store, for each value intended to be stored in the secondary memory, the address of said value in the main memory, and wherein the data vector of the firmware specifies, for each of the values intended to be stored in the secondary memory, an indication of the location of said value within the secondary memory.

15. Computing device according to claim 1, wherein the indexed loading block further comprises at least one counter configured to count the data exchanged by the indexed loading block.
